(19) United States
(12) Patent Application Publication
(10) Pub. No.: US 2015/0127190 A1
(43) Pub. Date: May 7, 2015

(54) METHOD FOR PREVENTING A COLLISION OF A MOTOR VEHICLE WITH A VEHICLE DRIVING THE WRONG WAY AND A CONTROL AND DETECTION DEVICE FOR A VEHICLE TO PREVENT A COLLISION OF THE MOTOR VEHICLE WITH A VEHICLE DRIVING THE WRONG WAY

(71) Applicant: Robert Bosch GmbH, Stuttgart (DE)

(72) Inventor: Thomas FUEHRER, Stuttgart-Weilimdorf (DE)

(21) Appl. No.: 14/533,656

(22) Filed: Nov. 5, 2014

(30) Foreign Application Priority Data
Nov. 7, 2013 (DE) 10 2013 222 586.5

(51) Int. Cl. B60W 30/09

(52) U.S. Cl. CPC B60W 30/09
USPC 701/1

(57) ABSTRACT

A method for preventing a motor vehicle from colliding with a vehicle driving the wrong way includes a wrong-way driver warning received by the motor vehicle, the traffic situation ahead of and beside the motor vehicle is detected with a sensor system, and it is checked, based on the detected traffic situation, to ascertain whether an evasive maneuver of the motor vehicle is initiate-able and an automatic evasive maneuver is initiated as a function of the check. A control and detection device for preventing collision with a vehicle driving the wrong way includes an arrangement for receiving a wrong-way driver warning, an arrangement for detecting the traffic situation ahead of and beside the motor vehicle, an arrangement for checking, configured for checking, based on the detected traffic situation, whether an evasive maneuver of is initiate-able, and an arrangement for initiating an automatic evasive maneuver based on the check.

### RELATED APPLICATION INFORMATION

The present application claims priority to and the benefit of German patent application no. 10 2013 222 586.5, which was filed in Germany on Nov. 7, 2013, the disclosure of which is incorporated herein by reference.

### FIELD OF THE INVENTION

The present invention relates to a method for preventing a collision of a motor vehicle with a vehicle driving the wrong way and a control and detection device for a vehicle to prevent a collision of the motor vehicle with a vehicle driving the wrong way.

### BACKGROUND INFORMATION

Wrong-way drivers cause fatalities, injuries and considerable property damage in the event of an accident. Driving the wrong way is understood here to refer to driving against the prescribed driving direction in a one-way roadway. A one-way roadway is a roadway separated structurally from oncoming traffic. One-way roadways are found on freeways or expressways, such as expanded federal roads. Driving the wrong way may be subdivided into driving forward and driving in reverse, forward driving being initiated by entering at the wrong ramp or by carrying out a U-turn.

Accidents occur in particular with wrong-way driving on freeways due to the high driving speeds and the associated high collision speeds, frequently resulting in fatalities.

Patent document DE 10 2010 051 245 A1 discusses a method for generating and outputting warning signals in traffic disruptions, in which the Traffic Message Channel (TMC) receives messages about traffic disruptions and the distance between the disruption and the vehicle is ascertained and a warning signal is output.

### SUMMARY OF THE INVENTION

The method according to the present invention for preventing a collision of a motor vehicle with a vehicle driving the wrong way basically includes the following steps:
receiving a wrong-way driver warning through the motor vehicle;
detecting the traffic situation ahead of and beside the motor vehicle with the aid of the sensor system of the motor vehicle;
checking, based on the detected traffic situation, whether an evasive maneuver of the motor vehicle is initiable;
Initiating an automatic evasive maneuver of the motor vehicle as a function of the result of the check.

The method according to the present invention has the advantage that existing sensor systems, for example, assistance systems, are used in combination with an external wrong-way driver warning to safely and reliably prevent a collision.

The wrong-way driver warning may be transmitted wirelessly by a transmitter. For example, the warning may be transmitted over a traffic channel of the radio or a navigation system, such as the Traffic Message Channel (TMC), or other services, such as mobile radio communication, social networks and/or cloud applications. These transmission channels and protocols are widely available and allow a safe and reliable transmission as the basis for the method.

Traffic beyond the range of the sensor system is advantageously detected via a communications network. Traffic here is understood to be vehicles which are sharing the road with the motor vehicle or could drive onto the road. Communications networks here include, for example, CAR2CAR, CAR2X, mobile radio communication and/or social networks. This makes it possible to expand the detection range of the vehicle-based sensor system since the sensor system may be used by vehicles in the vicinity, which may be preceding vehicles ahead of the motor vehicle. The information base, which is thereby expanded, increases the safety and reliability of this method.

The conditions of a roadway on which the motor vehicle is situated may be detected on the basis of map information in a navigation system and/or via a communications network. Information about the road such as curves, intersections or changes in the road surface, such as a reduction in the number of lanes, may also enter into the decision process, which further increases safety. For example, CAR2CAR, CAR2X, mobile radio communication and/or social networks may be considered as communications networks here.

According to one specific embodiment of the present invention, it is provided that the traffic situation behind the motor vehicle is detected. The term “traffic situation” here combines at least the traffic and the conditions of the roadway. Additional information or criteria, such as the weather conditions, for example, may also be included. Thus, any evasive maneuvers may be coordinated with the following traffic, which thus increases the safety of the entire traffic situation.

In one particular specific embodiment, it is provided that the wrong-way driver warning includes driving lane information, which indicates the affected driving lane of the vehicle driving the wrong way. This differentiated consideration may further increase safety. A standard evasive maneuver may be to change to a driving lane on the right of the affected driving lane.

Based on the driving lane information, the check and/or initiation may take place in such a way that the motor vehicle uses a different lane than the affected lane. Thus one may either remain in a lane not affected or may change to a lane not affected.

According to one specific embodiment of the present invention, it is provided that the automatic evasive maneuver is implemented with the aid of a steering support of the motor vehicle and/or a torque distribution of the wheels of the motor vehicle. These arrangements, which are already present in the motor vehicle, are able to carry out a lane change quickly and safely.

If the vehicle driving the wrong way changes lanes, this method may be repeated at least in part, based on a renewed wrong-way driver warning. Safety may be further increased by this iteration, i.e., response to the vehicle driving the wrong way, since it is possible to respond directly to changes by the driver driving the wrong way.

According to the present invention, a control and detection device for a motor vehicle is made available to prevent a collision of the motor vehicle with a vehicle driving the wrong way, which includes:
arrangement for receiving a wrong-way driver warning;
arrangement for detecting the traffic situation ahead of and beside the motor vehicle;
arrangement for checking, configured for checking, based on the detected traffic situation, whether an evasive maneuver on the part of the motor vehicle may be initiated;
arrangement for initiating an automatic evasive maneuver on the part of the motor vehicle as a function of the results of the check.

The same advantages and modifications apply as those described above.

The arrangement for receiving a wrong-way driver warning may be, for example, a communications interface of a mobile telephone or of the motor vehicle. The arrangement for detecting the traffic situation may be, for example, a sensor system of the motor vehicle. The arrangement for checking may be, for example, a control unit of the motor vehicle. The arrangement for initiation may be, for example, a steering support and/or a torque distribution of the wheels.

Advantageous refinements of the present invention are defined and described in the description.

Exemplary embodiments of the present invention are explained in greater detail on the basis of the drawings and the following description.

### BRIEF DESCRIPTION OF THE DRAWINGS

FIG. 1 shows a road with motor vehicles and a vehicle driving the wrong way.

FIG. 2 shows a schematic diagram of a motor vehicle.

FIG. 3 shows, in the form of a flow chart, a method for preventing a collision of a motor vehicle with a vehicle driving the wrong way.

### DETAILED DESCRIPTION

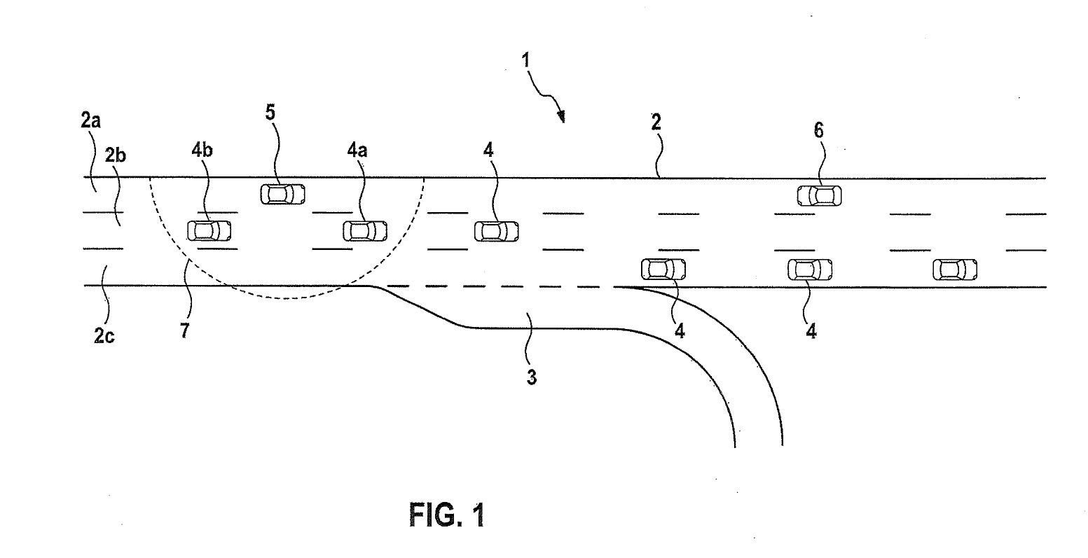

FIG. 1 shows a part of a roadway 1, such as an expressway or a freeway having a one-way roadway 2. One-way roadway 2 has a prescribed driving direction, running from left to right here. One-way roadway 2 has three lanes 2a, 2b and 2c, lane 2a being situated in the driving direction at the left, lane 2b being situated in the center and lane 2c being situated at the right.

In the course of one-way roadway 2, there is an exit or off-ramp 3, which is connected to right lane 2c. This example is based on right-hand traffic, but the discussions and figures also apply analogously to left-hand traffic.

This shows multiple vehicles or motor vehicles 4, which are using roadway 1 in the prescribed driving direction. A motor vehicle 5 is considered in particular below for preventing a collision of motor vehicle 5 with a vehicle 6 driving the wrong way. Two other motor vehicles 4a and 4b driving correctly are situated near motor vehicle 5. Motor vehicle 5 has sensor systems for detecting the traffic situation around motor vehicle 5. A detection range 7 of the sensor system is shown as an example. Both vehicles 4a and 4b are situated within detection range 7 and are therefore detected by the sensor system.

The terms “vehicle” and “motor vehicle” are understood here to refer to all driven transportation arrangement, such as, for example, passenger vehicles, trucks, buses, motorcycles, etc.

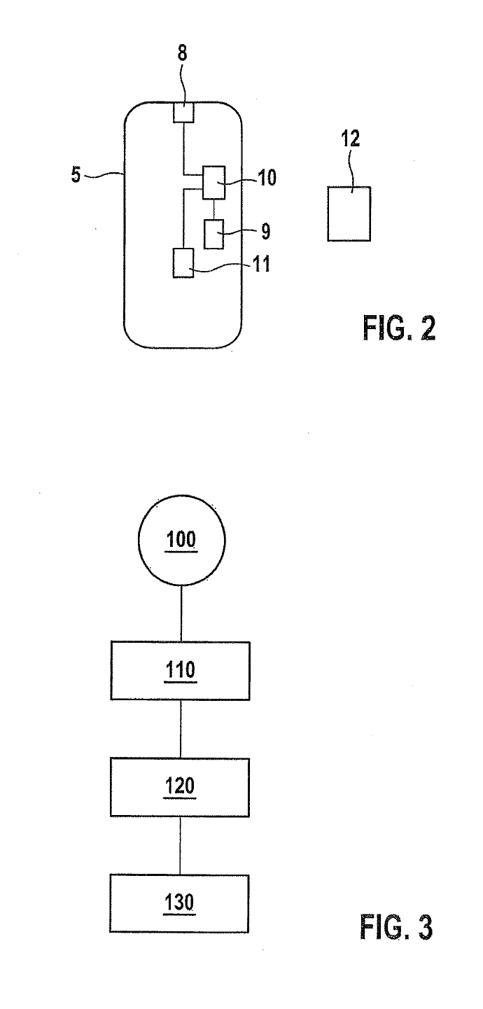

FIG. 2 schematically shows motor vehicle 5. Motor vehicle 5 includes at least one sensor system or at least one sensor 8 which is shown here as an example of a plurality of sensors. Sensor system 8 may include, for example, one or multiple image sensors such as a video camera, radar sensors, acceleration sensors, wheel sensors, distance sensors or other appropriate sensor. In particular, sensors and their signal processing include analysis of driver assistance systems. These may be systems such as adaptive cruise control (ACC), a lane keeping system (LKS), a lane departure warning (LDW), a lane change assistant (LCA) and/or a blind spot detection system (BSD).

Motor vehicle 5 also includes a navigation unit 9 and a control or control unit 10. Control 10 is in communication with sensor 8 and with navigation unit 9, which may be either hardwired or wireless. Furthermore, the control is connected to a communications interface 11, which is configured to communicate with an external device 12, such as a central server or a transmitter for wrong-way driver warnings.

Sensor 8, navigation device 9, control 10 and communications interface 11 may be configured as independent units, as shown here, or they may be integrated into one or multiple units. In particular it is not necessary for each component to be configured as hardware; likewise, individual functions may also be implemented as software routines or programs.

In addition to the wrong-way driver warnings, information such as map data and/or functionalities such as access to programs of external device 12 may be made available to motor vehicle 5 with the aid of communications interface 11.

On the basis of FIG. 3 in conjunction with FIG. 1, a method for preventing a collision of a motor vehicle 5 with vehicle 6 driving the wrong way will be described now.

In a first step 100, motor vehicle 5 receives a wrong-way driver warning from external device 12. The wrong-way driver warning indicates that vehicle 6 driving the wrong way is driving on roadway 1. In addition, the position of wrong-way driver 6, including the lane, i.e., lane 2a here, may also be transmitted. It is also possible for external device 12 to calculate the distance between vehicle 6 driving the wrong way and motor vehicle 5 based on a position message of motor vehicle 5 and to report this information to motor vehicle 5. The wrong-way driver message or warning may also originate from another vehicle 4, which has wrong-way driver 6 within its range of detection.

Sensor system 8 of motor vehicle 5 may be activated or put in a special mode for preventing a collision with a wrong-way driver 6 when a wrong-way driver warning has been received or when a relevance is detected, i.e., there is a spatial relationship between wrong way driver 6 and host motor vehicle 5.

In another step 110, the traffic situation around motor vehicle 5 is detected with the aid of sensor system 8 of motor vehicle 5. Within detection range 7 of sensor system 8, the traffic situation is detected in particular ahead of and beside motor vehicle 5, but also behind motor vehicle 5. Thus it is detected in particular that vehicles 4a and 4b are in lane 2b, host motor vehicle 5 is in lane 2a, and lane 2c is free of vehicles. Furthermore, the distances between motor vehicle 5 and two vehicles 4a and 4b are also ascertained. Furthermore, one's own speed, i.e., the speed of motor vehicle 5, and also the speeds of motor vehicles 4a and 4b, may be detected or determined.

In addition, the traffic situation beyond detection range 7 of sensor system 8 is also determined. For this purpose, in communication with additional motor vehicles, their detected traffic situation is utilized. Thus, for example, in communication with motor vehicle 4a, the presence and/or speed of vehicle 4 directly preceding this one may be ascertained. Furthermore, the conditions of roadway 1, such as the further course of the road, are detected on the basis of map material in navigation system 9. For example, the presence of exit ramp 3 may also be taken into account in the check to be carried out later. Exit ramp 3 may then be utilized for evasion purposes, for example.

The lateral traffic to motor vehicle 5, i.e., vehicles 4a and 4b, may be detected by using a blind spot detection system, for example. The traffic approaching from the rear, for example, vehicle 4b, may be detected by a lane change assistant, for example. Preceding traffic may be detected by an adaptive cruise control, for example.

Since the traffic situation, i.e., both the moving traffic and the conditions of roadway 1, have been detected by motor vehicle 5, now in an additional step 120, it is checked whether an evasive maneuver by motor vehicle 5 is initiable. For example, if multiple evasive maneuvers are possible, it is checked which evasive maneuver is the most promising for success. Criteria of this check may include, for example, the speed of the evasive maneuver, the lowest possible risk to the host motor vehicle and other vehicles or the like.

It is checked initially whether an evasive maneuver is necessary. In this case, the wrong-way driver warning contains the information that wrong-way driver 6 is in lane 2a. This is identical to the lane in which motor vehicle 5 is situated. Thus, motor vehicle 5 must leave lane 2a before there is a collision of the two vehicles. Since motor vehicle 5 is already in left lane 2a, and one-way roadway 2 is bordered by a structural border at the left, an evasive maneuver in the driving direction to the right is checked. For this purpose, one's own speed, the speeds of both motor vehicles 4a and 4b, and the distances between motor vehicle 5 and both vehicles 4a and 4b are determined.

If this check reveals that an evasive maneuver from lane 2a to lane 2b between two vehicles 4a and 4b is possible, then a corresponding evasive route is calculated. The parameters for the evasive route, such as, for example, the steering angle, acceleration, deceleration, torque distribution on the wheels of motor vehicle 5, etc., are ascertained.

In another step 130, an automatic evasive maneuver by motor vehicle 5 is initiated as a function of the carried out check. Motor vehicle 5 is then controlled with the aid of the ascertained parameters and the evasive maneuver is carried out. For this purpose, systems of motor vehicle 5 such as a steering support or electronic or hydraulic steering and/or an electronic stability program (ESP) or the like is used for a targeted intervention into the torque distribution of the wheels.

After conclusion of the automatic evasive maneuver, motor vehicle 5 is in lane 2b and therefore is no longer in lane 2a, which is affected by wrong-way driver 6. This prevents a collision.

If wrong-way driver 6 then switches to another lane, for example, from lane 2a to middle lane 2b, where motor vehicle 5 is now located, the preceding steps are carried out again.

This method need not be carried out in the sequence of steps described here. Instead, the two steps of detection 110 and checking 120 may run constantly in the background of the drive of motor vehicle 5. These steps, in particular check 120, are activated only on receipt of a wrong-way driver warning according to step 100.

What is claimed is:

1. A method for preventing a collision of a motor vehicle with a vehicle driving the wrong way, the method comprising:
receiving a wrong-way driver warning through the motor vehicle;
detecting the traffic situation ahead of and beside the motor vehicle with the sensor system of the motor vehicle;
checking, based on the detected traffic situation, whether an evasive maneuver is initiate-able by the motor vehicle; and
initiating an automatic evasive maneuver by the motor vehicle as a function of the results of the check.

2. The method of claim 1, wherein the wrong-way driver warning is transmitted wirelessly by a transmitter.

3. The method of claim 1, wherein traffic beyond the range of the sensor system is detected via a communications network.

4. The method of claim 1, wherein conditions of a roadway on which the motor vehicle is situated are detected based on map information in a navigation system and/or via a communications network.

5. The method of claim 1, wherein the traffic situation behind the motor vehicle is detected.

6. The method of claim 1, wherein the wrong-way driver warning includes a piece of lane information, which indicates an affected lane of the vehicle driving the wrong way.

7. The method of claim 6, wherein based on the lane information, the check and/or the initiation occurs so that the motor vehicle uses a different lane than the affected lane.

8. The method of claim 1, wherein the automatic evasive maneuver is implemented with a steering support of the motor vehicle and/or a torque distribution of the wheels of the motor vehicle.

9. The method of claim 1, wherein in the event of a lane change of the vehicle driving the wrong way, the method is repeated at least in part, based on a renewed wrong-way driver warning.

10. A control and detection device for a motor vehicle to prevent a collision of the motor vehicle with a vehicle driving the wrong way, comprising:
a receiving arrangement to receive a wrong-way driver warning;
a detecting arrangement to detect the traffic situation ahead of and beside the motor vehicle;
a checking arrangement to check, configured for checking, based on the detected traffic situation, whether an evasive maneuver of the motor vehicle is initiate-able; and
an initiating arrangement to initiate an automatic evasive maneuver by the motor vehicle as a function of the result of the check.
